(19) United States
(12) Patent Application Publication
(10) Pub. No.: US 2010/0066691 A1
(43) Pub. Date: Mar. 18, 2010

(54) INPUT APPARATUS AND COMPUTER READABLE RECORDING MEDIUM RECORDED WITH IMAGE PROCESSING PROGRAM

(76) Inventor: Ai Long LI, Shanghai (CN)

Correspondence Address: BIRCH STEWART KOLASCH & BIRCH, PO BOX 747, FALLS CHURCH, VA, 22040-0747, US

(21) Appl. No.: 12/469,050

(22) Filed: May 20, 2009

(30) Foreign Application Priority Data
Sep. 16, 2008 (CN) 200810149670.4

(51) Int. Cl. G06F 3/041

(52) U.S. Cl. 345/173

(57) ABSTRACT

A handwriting input apparatus and a computer readable recording medium recorded with an image processing program are provided, which both enable easy edit and high-quality display of edited content. A defining module defines a locus of a character and/or graphic contained in a group. When a gesture indicative of an edit command is inputted by a handwriting input module, then an edit management module interprets the inputted command and executes it. At this time, the execution of the command accompanies movement of the character and graphic in the group, and this movement follows the defined locus.

### CROSS-REFERENCE TO RELATED APPLICATION

This application claims priority to Chinese Patent Application No. 200810149670.4, which was filed on Sep. 16, 2008, the contents of which are incorporated herein by reference in its entirety.

### BACKGROUND OF THE INVENTION

1. Field of the Invention

The present invention relates to an input apparatus for inputting information and to a computer readable recording medium recorded with an image processing program.

2. Description of the Related Art

Information processing systems have input apparatuses for inputting information, among which handwriting input means is friendly for most users. Handwriting does not take an expert and has general versatility, and handwriting input means is of the longest use. In addition, there is a tendency that if handwriting is available, users select a handwriting mode for input and management. Now that a greater number of electronic appliances include pen interfaces which have been made available as information input and operating means, and such electronic appliances have been widely used indeed, it is necessary to develop effective electronic devices by advancing those interfaces.

Japanese Unexamined Patent Publication JP-A 1-161483 (1989) discloses a document edit device in which a combination of mixed graphics and text is easily edited through similar operation to making a correction on paper by hand, by recognizing a correction symbol when inputted; directly detecting a character and a graphic located close to the inputted correction symbol out of already stored text data and graphic data to be edited; and estimating edit content that an operator intends.

In JP-A 1-161483, system and processing are disclosed for capturing and executing handwritten gestures. A user inputs a swift command to a pen-equipped input device by making a gesture, thus allowing a task to be executed. In an Example, text or handwritten ink is editable by a user with use of a pen provided on a computing platform, and an outcome of such edit operation will be reflected to the text or ink.

In the technique disclosed in JP-A 1-161483, the handwritten correction symbol is used as an edit command, but what is edited is text data previously inputted. Moreover, the edit operation includes only designation of an edit region and for example, as to deletion, if the content in the defined edit region is deleted, then a substitute graphic (which is a line in the Example) is displayed to fill the region of which content has been deleted.

The edited region will thus end up with unnatural text or image displayed.

Although JP-A 1-161483 discloses that a task is executed according to a user's swift command inputted in the form of gestures to the pen-equipped input device, there is no disclosure of how the task is concretely done.

Japanese Unexamined Patent Publication JP-A 7-182449 (1995) discloses the technique that handwritten input data divided character by character is adjusted to have the characters aligned in a line based on line information, but all the characters in the line are inevitably arranged in parallel with those in another line. The technique is therefore not available for characters which are not supposed to be arranged in parallel.

### SUMMARY OF THE INVENTION

An object of the invention is to provide a handwriting input apparatus and a computer readable recording medium recorded with an image processing program, which both enable easy edit and high-quality display of edited content.

The invention provides an input apparatus comprising:

a handwritten character and/or graphic input device for inputting a character and/or graphic written by hand;

a storage unit for storing handwritten data constituted of handwritten characters and/or graphics inputted by the handwritten character and/or graphic input device;

a handwritten edit command input device for inputting a command of editing the handwritten data by hand;

an input direction detecting unit for detecting an input direction of handwriting a group consisting of a set of characters and/or graphics contained in the handwritten data;

an edit management unit for detecting a command when the command is inputted by the handwritten edit command input device, and controlling the characters and/or graphics in the group so as to move in the input direction during execution of the command; and

a display unit for displaying the handwritten data, handwritten data which has not yet been edited by the edit management unit, and handwritten data which has been edited after the execution of the edit command.

According to the invention, when a command for edit is inputted by the handwritten edit command input device, the inputted command is executed while the characters and/or graphics in the group is moved in the input direction detected by the input direction detecting unit, and then the edited handwritten data are displayed on the display unit.

The character and/or graphic is thus moved and since this movement is parallel to the input direction, the edit process can be conducted with simple operation and thereafter the edited content can be displayed with high visual quality.

Further, in the invention, it is preferable that the input direction detecting unit detects a rectangle circumscribing each of characters and/or graphics contained in the group and detects a geometric center of the detected circumscribing rectangle to determine a locus connecting all points of the detected geometric center.

According to the invention, the input direction detecting unit detects a rectangle circumscribing each of characters and/or graphics contained in the group and detects a geometric center of the detected circumscribing rectangle to determine a locus connecting all points of the detected geometric center.

The edited characters and/or graphics are thus moved along the locus, with the result that the edited content can be displayed with higher visual quality.

Further, in the invention, it is preferable that the edit command includes a deletion command, and

when the deletion command is inputted as a handwritten edit command, the edit management unit deletes a character and/or graphic to be deleted and causes a character and/or graphic located after the deleted character and/or graphic in the input direction to move forward in the input direction so as to follow the locus.

According to the invention, in response to a deletion command inputted as the handwritten edit command, the character and/or graphic to be deleted is deleted and the character and/or graphic located after the deleted character and/or graphic in the input direction is moved forward in the input direction so as to follow the locus.

As a result, neither blanks nor substitute patterns appear in the part where the deleted object used to be, and the content displayed becomes closed up for the deleted object, which allows the edited content to be displayed with a higher visual quality.

Further, in the invention, it is preferable that the edit command includes a correction command, and

when the correction command is inputted as a handwritten edit command, the edit management unit deletes a character and/or graphic to be corrected; when a character and/or graphic to be corrected is inputted by the handwritten character and/or graphic input device, detects a rectangle circumscribing the inputted character and/or graphic and a graphic center of the circumscribing rectangle; and places the inputted character and/or graphic to be corrected so as to have the detected graphic center positioned on the locus.

According to the invention, in response to a correction command inputted as a handwritten edit command, the object to be corrected is deleted and then, when a character and/or graphic to be corrected is inputted by the handwritten character and/or graphic input device, a rectangle circumscribing the inputted character and/or graphic and a graphic center of the detected circumscribing rectangle are detected, and instead of the deleted object to be corrected, the inputted character and/or graphic to be corrected is placed so that the detected graphic center is positioned on the locus.

The arrangement of the characters and/or graphics before correction is thus reflected to the arrangement of the newly inputted character and/or graphic to be corrected, with the result that the edited content can be displayed with higher visual quality.

Further, in the invention, it is preferable that the edit command includes an insert command, and

when the insert command is inputted as a handwritten edit command, the edit management unit moves along the locus a character located before or after an insert position in the input direction so as to make a predetermined space in between a character and/or graphic located after the insert position in the input direction and a character and/or graphic located before the insert position in the input direction; detects a rectangle circumscribing a character and/or graphic to be inserted which is inputted by the handwritten character and/or graphic input device, and a geometric center of the rectangle; and places the inputted character and/or graphic to be inserted so as to have the detected geometric center positioned on the locus in the space.

According to the invention, in response to an insert command inputted as a handwritten edit command, the character and/or graphic before or after the insert position in the input direction is moved along the locus so as to make a predetermined space in between the character and/or graphic located after the insert position in the input direction and the character and/or graphic located before the insert position in the input direction.

Furthermore, the rectangle circumscribing the character and/or graphic to be inserted, inputted by the handwritten character and/or graphic input device, and the geometric center of the circumscribing rectangle are detected, and the inputted character and/or graphic to be inserted is placed so that the detected geometric center is positioned on the locus in the space.

In ensuring the space for insertion, the character and/or graphic thus moves along the locus and moreover, the center of the character and/or graphic to be inserted is brought onto the locus in the space, with the result that the edited content can be displayed with a higher visual quality.

The invention provides a computer readable recording medium recorded with an image processing program for operating a computer as the above input apparatus.

According to the invention, it is possible to provide a computer readable recording medium recorded with an image processing program for operating an image processing apparatus which enables easy edit of character and/or graphic inputted thereto and is capable of displaying the edited content with a high visual quality.

### BRIEF DESCRIPTION OF THE DRAWINGS

Other and further objects, features, and advantages of the invention will be more explicit from the following detailed description taken with reference to the drawings wherein:

FIG. 1 is a block diagram schematically showing a hardware configuration of a multifunctional peripheral having an input apparatus according to one embodiment of the invention;

FIG. 2 is a view showing a module configuration of the input apparatus;

FIG. 3 is a flowchart showing an edit process in the input apparatus of the invention;

FIG. 4 is a view showing operation of an edit management module;

FIG. 5 is a view showing a data structure of a cache memory;

FIG. 6 is a view showing a data structure of a first database;

FIG. 7 is a view showing a data structure of a second database;

FIGS. 8A and 8B are views each showing one example of a locus in a case of one line;

FIGS. 9A and 9B are views each showing one example of a locus in a case of plural lines;

FIGS. 10A through 10C are views each showing an example of an edit gesture;

FIGS. 11A through 11C are views each showing a process for defining a locus;

FIGS. 12A and 12B are views each showing an example where a deletion command is inputted as edit content;

FIG. 13 is a view showing an example where a correction command is inputted as edit content;

FIG. 14 is a view showing an example where an insert command is inputted as edit content;

FIG. 15 is a view showing an example where an insert command is inputted as edit content;

FIG. 16 is a view showing an example where insertion reduces a visual quality of display;

FIG. 17 is a view showing an example where characters to be inserted are divided when inserted;

FIG. 18 is a view showing a process example of detecting rectangle circumscribing alphabets;

FIG. 19 is a view for explaining how to define a locus of alphabetic characters to be edited;

FIGS. 20A and 20B are views each showing an example where a deletion command is inputted as edit content;

FIG. 21 is a view showing an example where a correction command is inputted as edit content;

FIG. 22 is a view showing an example where an insert command is inputted as edit content;

FIG. 23 is a view for explaining how to define a locus of a flowchart to be edited;

FIG. 24 is a view showing an example where a deletion command is inputted as edit content in a case of editing a flowchart;

FIG. 25 is a view showing an example where a correction command is inputted as edit content in the case of editing a flowchart;

FIG. 26 is a view showing an example where an insert command is inputted as edit content in the case of editing a flowchart;

FIGS. 27A and 27B are views for explaining how to switch modes by hardware process; and

FIG. 28 is a view for explaining how to switch modes by software process.

### DETAILED DESCRIPTION

Now referring to the drawings, preferred embodiments of the invention are described below.

In the invention, handwritten objects and a handwriting locus thereof are defined, and handwritten gestures are made as edit commands for deletion, correction, insertion, etc. At this time, an edit task is performed without additional selection or manipulation. And after completion of the edit task, the handwritten objects are moved to proper positions and thus displayed with a high visual quality.

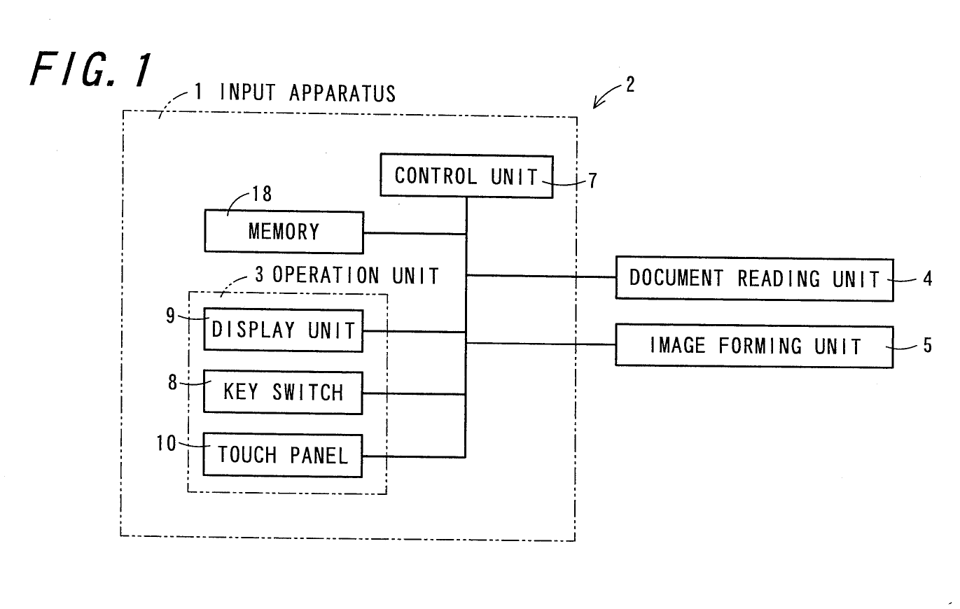

FIG. 1 is a block diagram schematically showing a hardware configuration of a multifunctional peripheral 2 having an input apparatus 1 according to one embodiment of, the invention. In FIG. 1, only a part relevant to copying operation, for example, is selectively shown to avoid complexity. The copying operation indicates a series of operation that includes (1) reading a document to create readout data based on the document and (2) forming an image on paper based on the readout data.

The multifunctional peripheral 2, which is an information processing system, has: an operation unit 3 operated by a user; a document reading unit 4 which reads a document and creates readout data based on the document; an image forming unit 5 which forms an image on paper based on readout data; a control unit 7; and a memory 18. The operation unit 3 has a key switch 8, a display unit 9 displaying a screen, and a touch panel 10 located on the front of the display unit 9. Information can be inputted to the multifunctional peripheral 2 by (1) operating the key switch 8 or (2) operating the touch panel 10.

The input apparatus 1 according to the present embodiment is used not only to input information but also to edit information (primarily text data) inputted in advance. The input information inputted by the input apparatus 1 includes a character and a graphic.

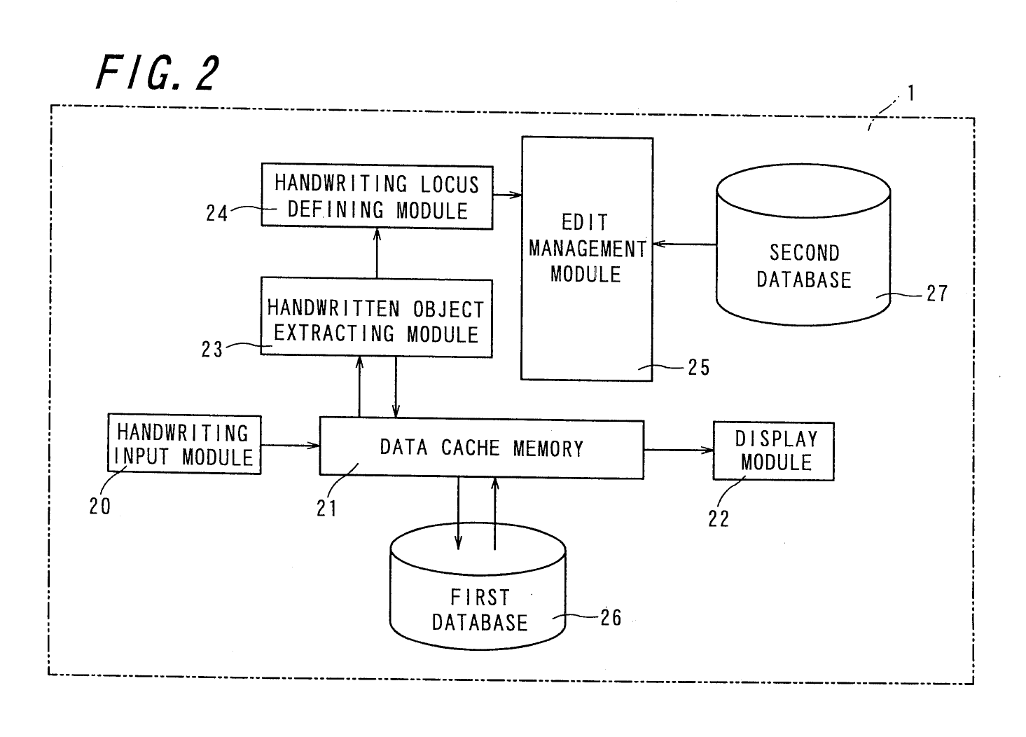

FIG. 2 is a view showing a module configuration of the input apparatus 1.

The input apparatus 1 is composed of a handwriting input module 20, a data cache memory 21, a display module 22, a handwritten object extracting module 23, a handwriting locus defining module 24, an edit management module 25, a first database 26, and a second database 27.

The handwriting input module 20 acquires coordinate locus data based on a coordinate which is inputted to the touch panel 10 and thereby readout. The coordinate locus data can be acquired through a heretofore known technique.

The data cache memory 21 is a storage region for temporarily storing the handwriting locus data and other data. A data structure of the data cache memory will be hereinbelow explained with other data structures.

The display module 22 functions as an interface for displaying on the display unit 9 and appropriately causes the display unit 9 to show a handwriting locus or text to be edited, for example.

The handwritten object extracting module 23 refers to locus data inputted by the handwriting input module 20, thereby determining whether or not what is inputted is a handwritten object. The locus data recognized as a handwritten object are registered while the other data not recognized as a handwritten object are discarded as erroneous data.

The handwriting locus defining module 24 defines an input locus representing the input direction and input position of each of handwritten objects in a group which contains a series of handwritten objects.

The edit management module 25, which has the most characteristic configuration in the invention, performs an edit task with reference to a defined edit object inputted by hand.

The first database 26 stores previously inputted handwritten text data and relevant information thereof. A data structure of the first database will be hereinbelow explained with other data structures.

The second database 27 stores handwritten gestures which are objects to be edited. A data structure of the second database will be hereinbelow explained with other data structures.

The input apparatus 1 of the invention is capable of not only the edit task but also character input by hand. The character input will be explained below.

In the first data base 26, a handwriting recognition dictionary is stored. In the handwriting recognition dictionary, a handwritten object pattern for each of characters and/or graphics is registered in advance. The handwritten object extracting module 23 compares the handwritten object inputted by the handwriting input module 20 with the handwritten object pattern for each of characters and/or graphics, thereby recognizing the character and/or graphic.

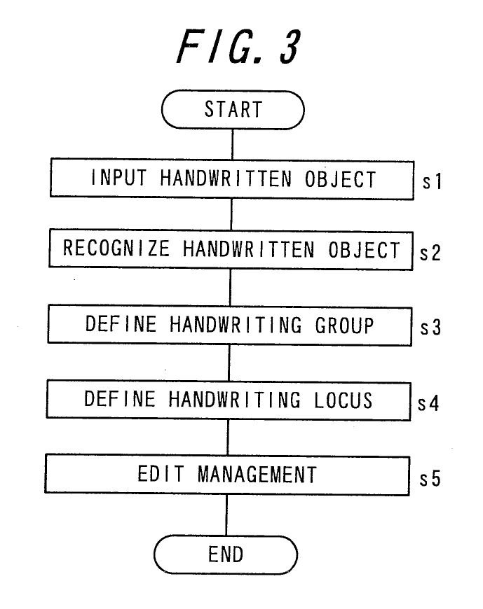

FIG. 3 is a flowchart showing an edit process in the input apparatus 1 of the invention.

In Step S1, a handwritten object is inputted by the handwriting input module 20 and then in Step S2, the handwritten object inputted by the handwriting input module 20 is referred to by the handwritten object extracting module 23 to be compared with the handwritten object pattern therein, whereby a character and/or graphic is recognized.

In Step S3, the recognized handwritten object is incorporated into a handwriting group and so defined. To be specific, a time threshold τ is set in advance and an idle time T in handwriting input is detected. The idle time T represents a lapse of time that has passed without coordinate input since a coordinate is last inputted to the touch panel 10. In the case of T>τ, the handwritten object which is inputted before the idle time T starts is defined as one handwritten object group.

In Step S4, a handwriting locus is defined. To be specific, the minimum rectangle (which will be hereinafter referred to as “circumscribing rectangle”) circumscribing each of handwritten objects in the defined handwritten object group is detected and a geometric center of each of circumscribing rectangle is also detected. The detected geometric centers are connected by a straight or curved line which is then extracted to define a handwriting locus.

In Step S5, edit management is conducted.

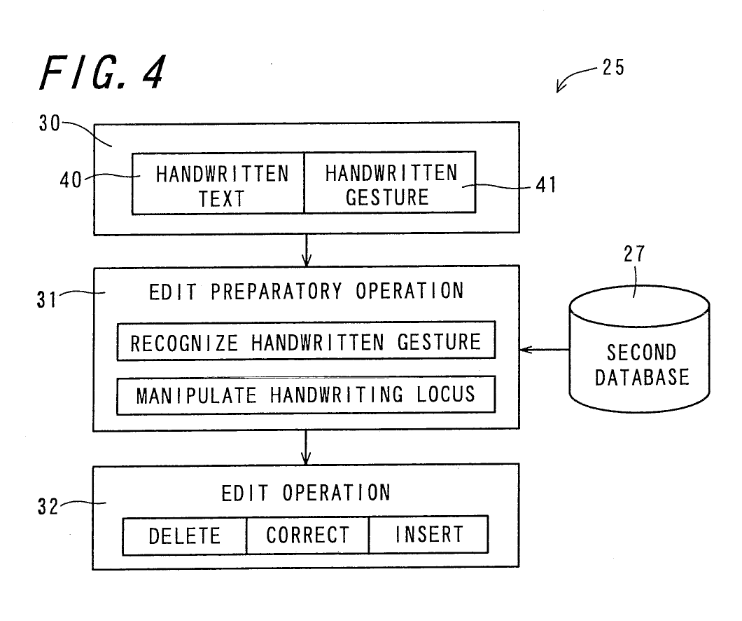

The edit management will be explained in detail below. FIG. 4 is a view showing operation of the edit management module 25.

The edit management module 25 receives the handwritten object, i.e. handwritten text 40 and a handwritten gesture 41, from the handwriting locus defining module 24 during receiving operation 30. Subsequently, during edit preparatory operation 31, the inputted handwritten gesture is compared with the handwritten gesture stored in the second database 27 and on the basis of this comparison, an edit command corresponding to the handwritten gesture is recognized. The edit command includes various commands primarily represented by a deletion command, a correction command, and an insert command. The edit management module 25 moreover reads the handwriting locus of the object to be edited.

During edit operation 32, the recognized edit command and handwriting locus are referred to in carrying out specific edit tasks, i.e. a deletion task, a correction task, and an insert task.

When the deletion task, the correction task, or the insert task is performed, the handwriting locus is manipulated. The manipulation of the handwriting locus is to move a character object along the handwriting locus as characters are deleted, replaced, or added according to the edit task. For example, in the case of deleting a designated character object, a character object following the designated object in the input direction is sequentially moved forward along the locus. Especially, in the case of carrying out the insert task, an increase in the number of characters will create need for extension of the previously defined locus so as to move a character object backward in the input direction. In this case, the locus is extended in accordance with predictions made based on the previously defined locus. Concrete processing of the deletion task, the correction task, and the insert task will be explained hereinbelow.

The description is now directed to the data structures of the data cache memory 21, the first databases 26, and the second database 27.

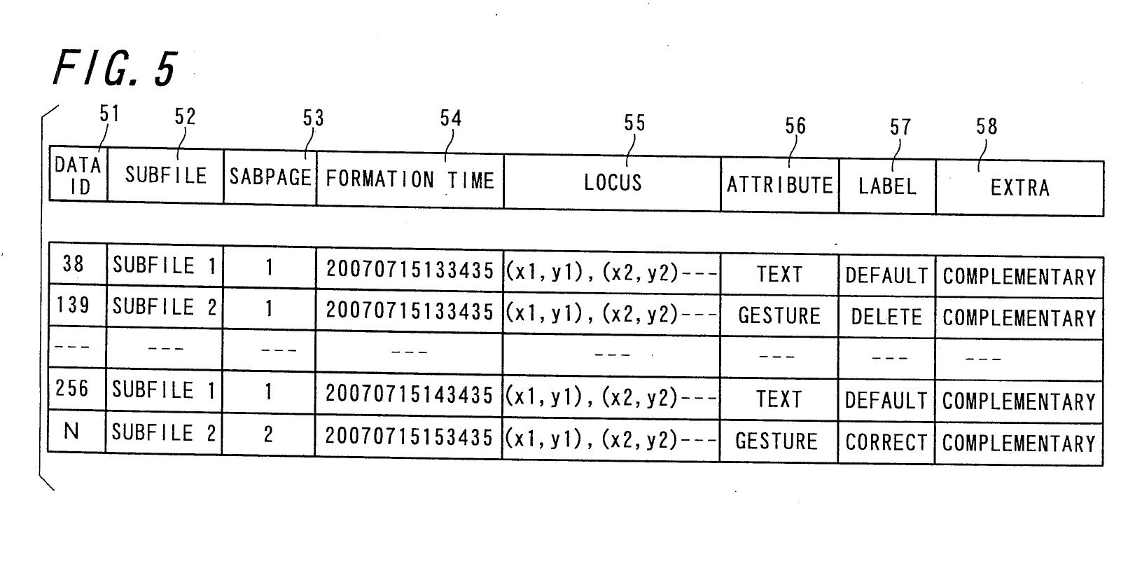

FIG. 5 is a view showing a data structure of the cache memory 21.

A data ID denoted by 51 is a serial number of the handwritten object in the cache memory 21. A subfile denoted by 52 is a numbered file to which the written object belongs. A subpage denoted by 53 is a numbered page in the file to which the written object belongs. A formation time denoted by 54 is a date and time (year, month, day, hour, minute, and second) when the handwritten object starts to be inputted. A locus denoted by 55 is locus data of the group to which the handwritten object belongs. An attribute denoted by 56 represents an attribute of the object, and an attribute of the object inputted online from outside of the apparatus is a default while an attribute of the handwritten object inputted from the handwritten object extracting module 23 or the edit management module 25 is text or a gesture. A label denoted by 57 is a label applied to the object, and a label of the object inputted online is a default while a label of the handwritten object inputted from the handwritten object extracting module 23 or the edit management module 25 is a default or edit content. In extra fields denoted by 58, complementary information is stated.

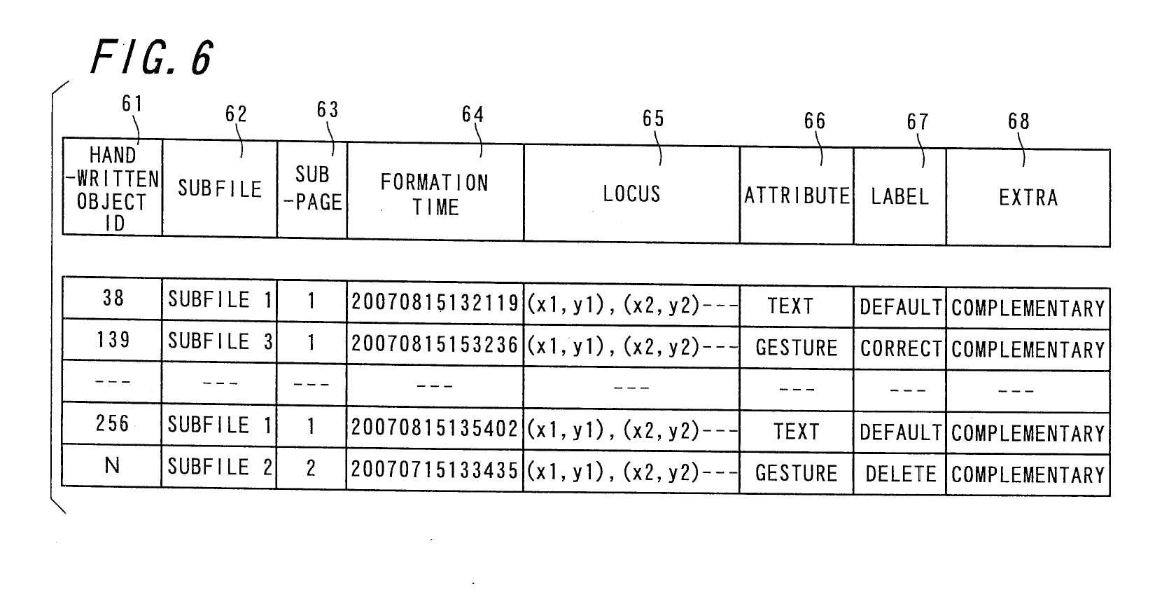

FIG. 6 is a view showing a data structure of the first database 26.

A handwritten object ID denoted by 61 is a serial number of the handwritten object in the first database 26. A subfile denoted by 62 is a numbered file to which the written object belongs. A subpage denoted by 63 is a numbered page in the file to which the written object belongs. A formation time denoted by 64 is a date and time (year, month, day, hour, minute, and second) when the handwritten object starts to be inputted. A locus denoted by 65 is locus data of the group to which the handwritten object belongs. An attribute denoted by 66 represents an attribute of the handwritten object, which is text or a gesture. A label denoted by 67 is a label applied to the object. In the case where the handwritten object is a gesture, an edit command corresponding to the label is stated, while in the case where the handwritten object is not a gesture, a default is stated. In extra fields denoted by 68, complementary information is stated.

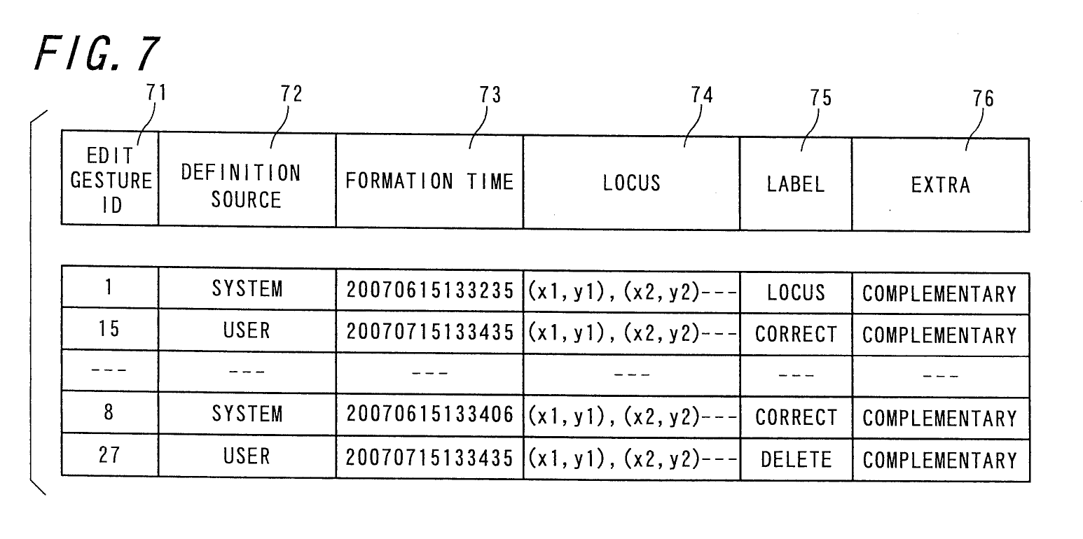

FIG. 7 is a view showing a data structure of the second database 27.

An edit gesture ID denoted by 71 is a serial number of the handwritten gesture in the second database 27. A definition source denoted by 72 represents a source which defines a gesture, and this field says SYSTEM when the gesture has been previously defined in the system while the filed says USER when the gesture is newly defined by a user. A formation time denoted by 73 is a date and time (year, month, day, hour, minute, and second) when the handwritten gesture starts to be inputted. A locus denoted by 74 is locus data of the group to which the handwritten gesture belongs. A label denoted by 75 is a label applied to the gesture and represents edit content. In extra fields denoted by 76, complementary information is stated.

Specific edit tasks will be explained below.

The feature of the edit tasks in the invention is to use a locus of a handwritten object group. The locus of the group according to the invention is a straight or curved line which is obtained by connecting geometric centers of rectangles each circumscribing a handwritten object as mentioned above. The geometric center may be, for example, the center of gravity.

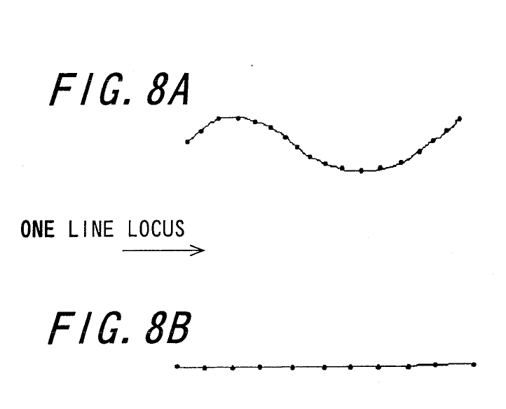

As shown in the locus examples of FIGS. 8A and 8B, the locus of a group consisting of one line is in form of one curved line (FIG. 8A) or one straight line (FIG. 8B). The locus of one line segment is defined to be inputted from left to right, for example.

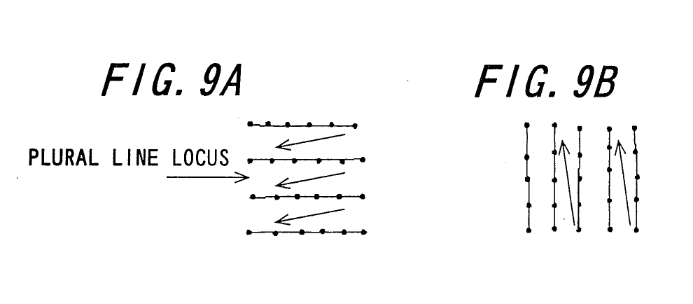

As shown in the locus examples of FIGS. 9A and 9B, the locus of a group consisting of plural lines is in form of a set of plural horizontally-extending segments (FIG. 9A) or a set of plural vertically-extending segments (FIG. 9B). In the set of plural horizontally-extending segments, one segment is defined to be inputted from left to right, for example, and a right end of the one segment is connected to a left end of next segment located just below the one segment. In the set of plural vertically-extending segments, one segment is defined to be inputted from top down, for example, and a bottom end of the one segment is connected to a top end of next segment located on an immediate left of the one segment.

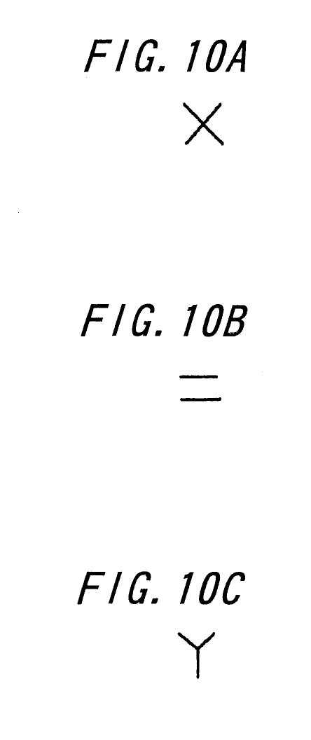

FIGS. 10A through 10C are views each showing an example of the handwritten gesture.

The default value for the handwritten gesture stored in the second database 27 is defined in advance in the apparatus. Note that the handwritten gesture may also be defined newly by a user. For a user to newly define a handwritten gesture, it is necessary to provide a learning function for recognizing the handwritten gesture.

The handwritten gesture may have any graphic form and is preferably defined based on a human interface which makes it easy for a user to instinctively understand edit content.

In the present embodiment, as shown in FIGS. 10A through 10C, a deletion gesture (FIG. 10A), a correction gesture (FIG. 10B), and an insert gesture (FIG. 10C) are defined. The deletion gesture is defined as an X-shaped object, the correction gesture is defined as a double-lined object, and the insert gesture is defined as a Y-shaped object.

Firstly, there is given an explanation of how Chinese characters are edited.

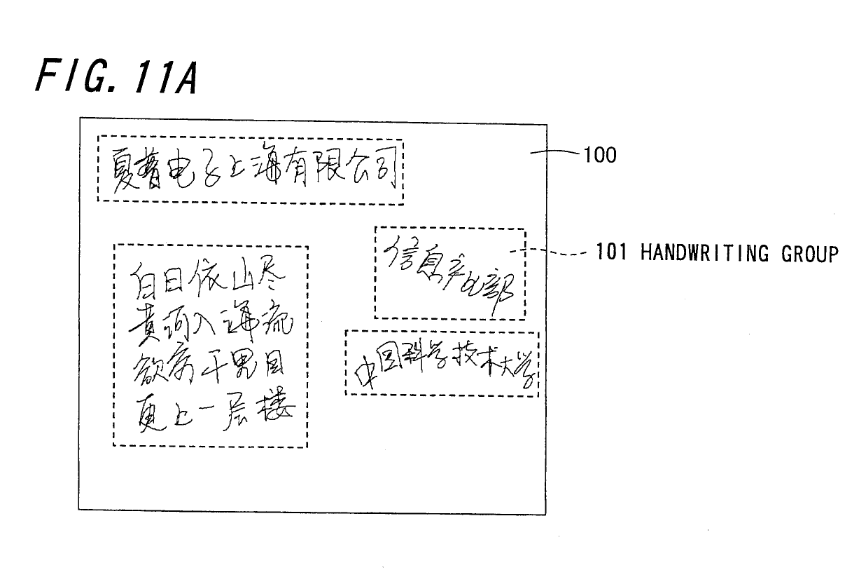

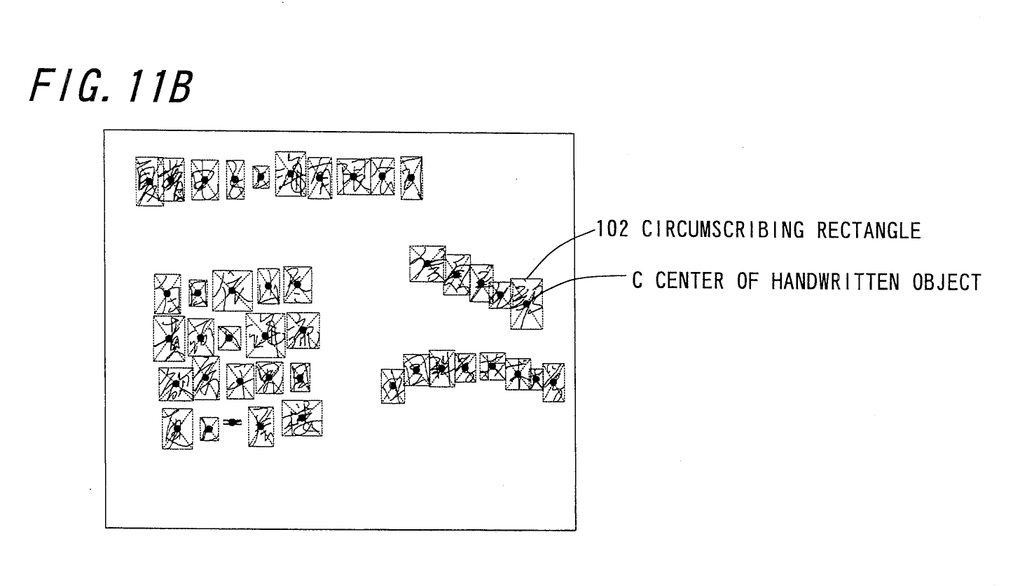

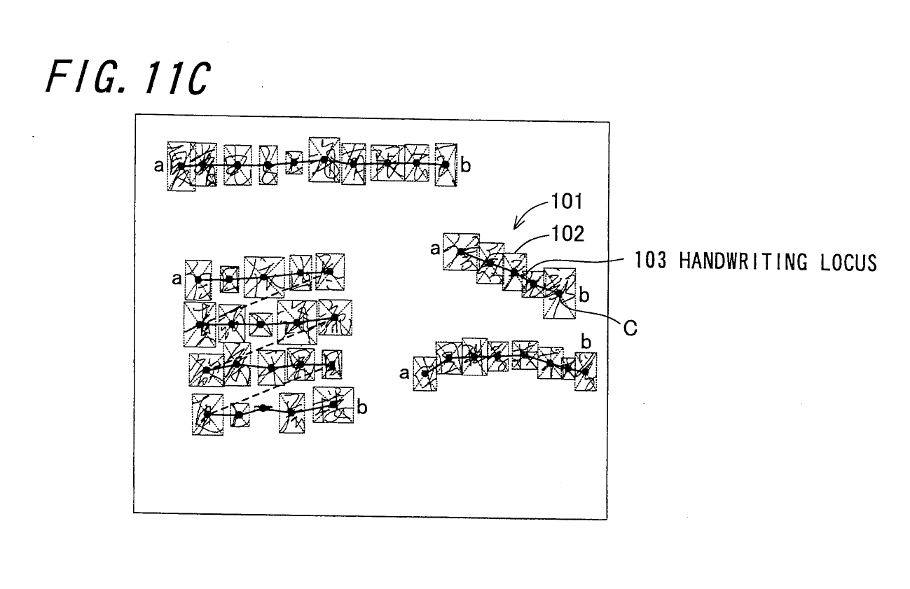

FIGS. 11A through 11C are views each showing a process for defining a locus. The handwritten gesture is inputted to a handwriting input region 100 which is set on the touch panel 10, etc., and there is defined a handwriting group 101 of characters which are handwritten objects (FIG. 11A). And for each of groups 101, a circumscribing rectangle 102 of each of handwritten objects contained in the group 101 is detected and a geometric center C of the circumscribing rectangle 102 is also detected (FIG. 11B).

After the center C is detected, all the centers C contained in one group 101 are connected to each other, thereby defining a locus 103 (FIG. 11C).

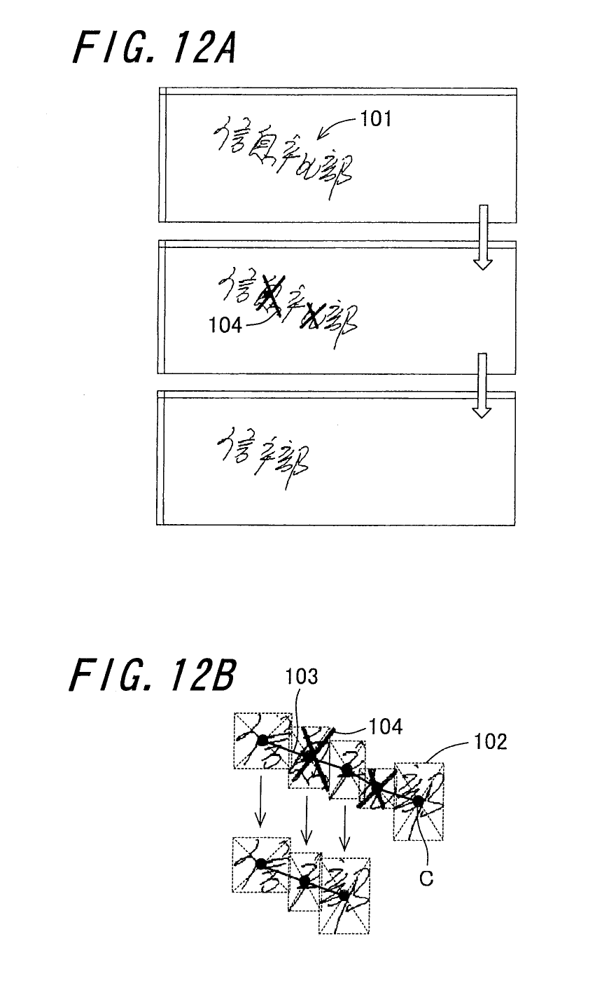

FIGS. 12A and 12B are views each showing an example where a deletion command is inputted as edit content. FIG. 12A shows a display example appearing in performing the deletion task and FIG. 12B shows a view showing concrete processing of display changes.

When the object “X”, namely a deletion gesture 104, is inputted to one group 101 displayed on the handwriting input region 100, then a character object located where the deletion gesture 104 is inputted is deleted, and a character object located after the deleted character object in the input direction is caused to move forward in the input direction so as to follow the locus 103. A renewed group is thus created and then displayed.

The character object to be deleted is recognized by detecting the circumscribing rectangle 102 including a coordinate (locus) where the deletion gesture 104 is inputted, and selecting a character object that corresponds to the detected circumscribing rectangle 102.

The object remaining after completion of the deletion task is moved so that the center C of the remaining character object is moved along the locus 103 until there will be a predetermined overlap region between the circumscribing rectangle 102 of the moving character object and the circumscribing rectangle 102 of another character object toward which the moving character object is heading.

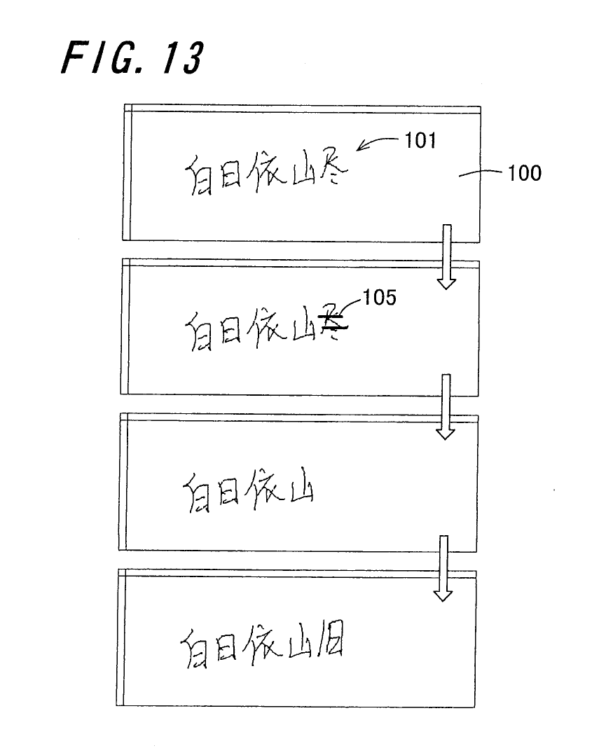

FIG. 13 is a view showing an example where a correction command is inputted as edit content.

When the object “=”, namely a correction gesture 105, is inputted to one group 101 displayed on the handwriting input region 100, then a character object located where the correction gesture 105 is inputted is deleted once. After that, a corrected character object is inputted and this inputted character object is then displayed instead of the deleted character object.

The object to be corrected is recognized by, as in the case of the deletion task, detecting the circumscribing rectangle 102 including a coordinate (locus) where the correction gesture 105 is inputted, and selecting a character object that corresponds to the detected circumscribing rectangle 102.

After input of the corrected character object, its circumscribing rectangle and a geometric center thereof are detected, and the corrected character object is placed so that its center is positioned on the locus and that there will be a predetermined overlap region between the circumscribing rectangle 102 of another character object adjacent to the position at which the character to be corrected used to be, and the circumscribing rectangle 102 of the corrected character object.

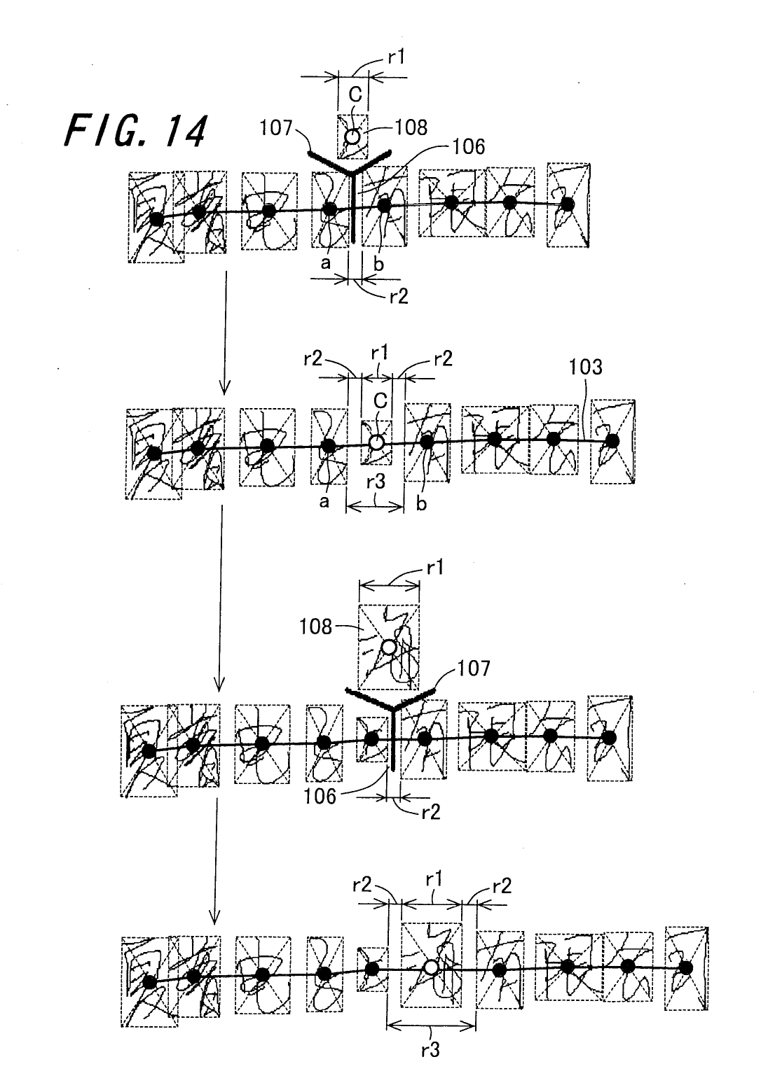

FIG. 14 is a view showing an example where an insert command is inputted as edit content.

In the case of inserting plural characters, the characters may be inserted sequentially one by one, or the plural characters may be regarded as one character and thereby inserted collectively. In the process shown by FIG. 14, the characters are inserted one by one.

For example, in the case of inserting two characters “ [symbol] ”, the object “Y”, namely an insert gesture 107, is firstly inserted at an insert position 106 in one group 101 displayed on the handwriting input region 100, each of character objects located after the insert position 106 in the input direction is moved along the locus 103 until there will be a predetermined distance between the each of character objects located after the insert position 106 in the input direction and the character object located before the insert position 106 in the input direction.

In this case, the character object located at the rearmost end of the group 101 has to move out of the range of the segment indicative of the locus 103 which therefore needs to extend back in the input direction, and along the locus 103 thus extended, the each character object located after the insert position 106 in the input direction moves.

The extension of the locus 103 can be achieved by the heretofore known technique.

The distance necessary for insertion is determined as follows. In editing by insertion, the input of the insert gesture 107 is followed by the input of the character object to be inserted. In the present embodiment, as shown in FIG. 14, a linear bottom part of the insert gesture 107 indicates the insert position 106, and the character object 108, i.e., “ [symbol] ” inputted above a V-shaped upper part of the insert gesture 107 is recognized as the character object to be inserted.

A width of a rectangle circumscribing the inputted character object to be inserted is obtained and represented by r1. A predetermined distance from the inserted character object to each of the adjacent character objects on either side is obtained and represented by r2. Using these figures r1 and r2, an insert distance r3 is determined through the expression; r3=r1+2×r2. It means that the locus 103 has to extend by at least the insert distance r3.

Moreover, in positioning the character object to be inserted, the respective centers of the adjacent character, objects on either side of the inserted character object are located, and the character object to be inserted is placed so as to have its center positioned on a locus connecting these two centers and at a middle position therebetween.

Subsequently, the second character “ [symbol] ” is inserted. The insert process of the second character is the same as that of the first character “ [symbol] ” and therefore will not be explained herein.

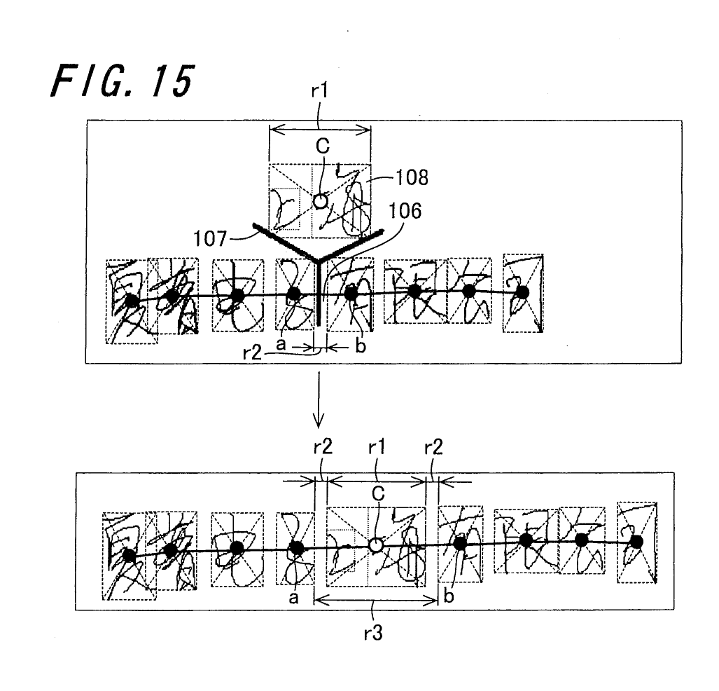

FIG. 15 is a view showing an example where an insert command is inputted as edit content.

In the process shown by FIG. 15, the plural characters are regarded as one character and thereby inserted collectively.

The process to insert the plural characters correctively is carried out by treating character objects of plural characters as one character object and therefore is almost the same as the process example shown in FIG. 14. A difference from the above process example is that when the insert gesture 107 is inputted and plural characters are inputted above the upper V-shaped part of the insert gesture 107, the plural characters are regarded as one character object and one rectangle circumscribing all the inserted characters is detected to conduct the process.

By the way, in the case where plural characters are inserted collectively, the visual quality hardly lowers as shown in FIG. 15, but under certain conditions the insertion may lower the visual quality.

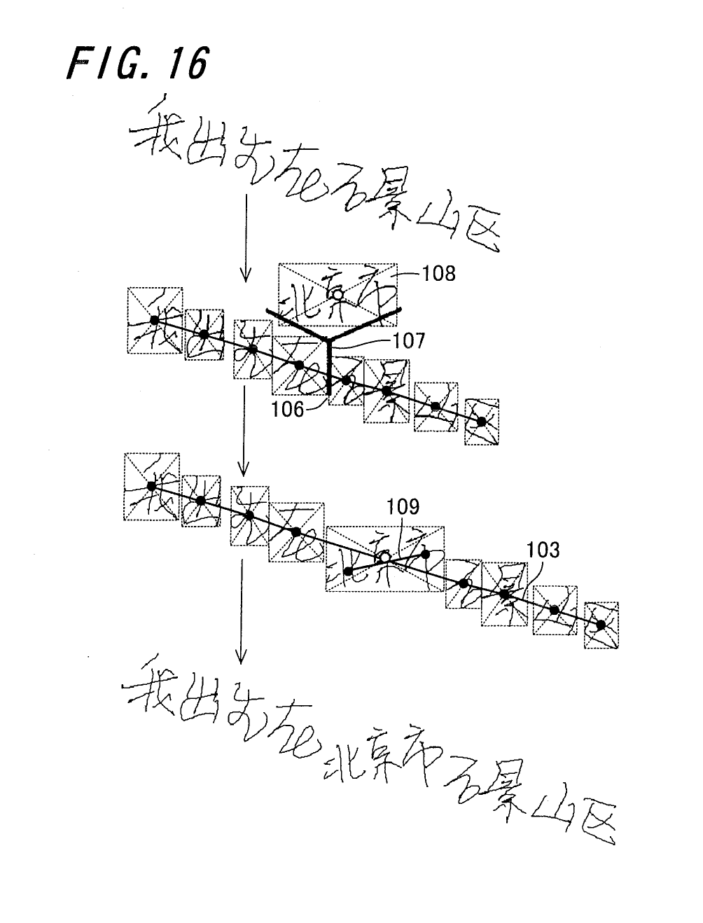

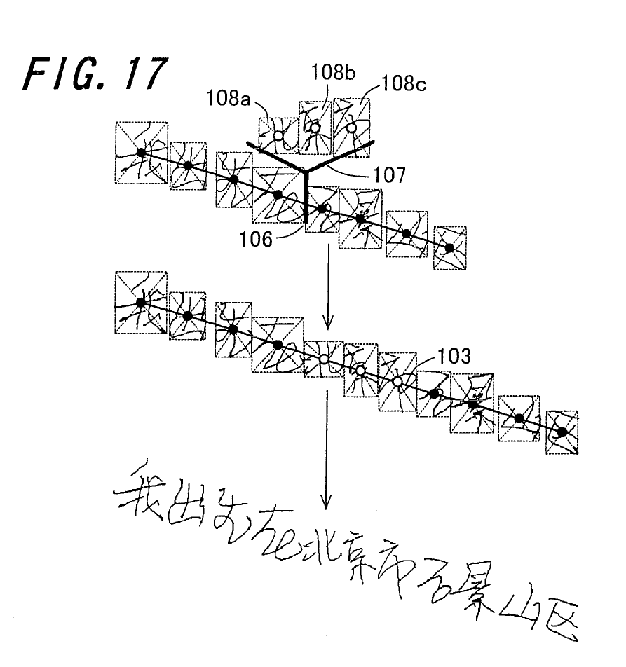

The certain conditions include a situation where plural characters to be inserted have a very different locus from a locus of a group into which the plural characters are to be inserted. Especially with a large number of characters inserted, the visual quality declines notably. For example, considering a case of inserting three characters “ [symbol] ” as shown in FIG. 16 where a locus 109 detected from the three characters “ [symbol] ” is a straight line rising from left to right while the locus 103 of the group into which the three characters are to be inserted is a straight line falling from left to right, the corrective insertion of the three characters “ [symbol] ” lowers the visual quality of characters displayed after the insertion as shown in the drawing, due to considerable variation in a locus of the resultant group.

In such a case, the inputted plural characters may be split one by one into respective character objects which are then inserted to one insert position 106.

In the case of inserting the three characters “ [symbol] ”, they are divided into three character objects; a character object “ [symbol] ” denoted by 108a, a character object “ [symbol] ” denoted by 108b, and a character object “ [symbol] ” denoted by 108c, and centers of respective circumscribing rectangles of these character objects are detected. After that, as in the case of character by character insertion shown in FIG. 14, these character objects may be inserted so as to have their centers all positioned on the locus.

Next, there is given an explanation of how alphabetic characters are edited.

While a locus of Chinese characters can be defined by firstly detecting a rectangle circumscribing each of characters and then detecting a center thereof, alphabets are handled differently in detecting their circumscribing rectangles.

For alphabets, which have different appearance and write characteristic from those of Chinese characters, it is not enough, for example, to only detect a rectangle circumscribing each word. Alphabets especially have very different vertical sizes from one character to another. Simply detecting a rectangle circumscribing one alphabetical word will end up defining the circumscribing rectangle with a height that corresponds to a vertical length of the vertically largest character.

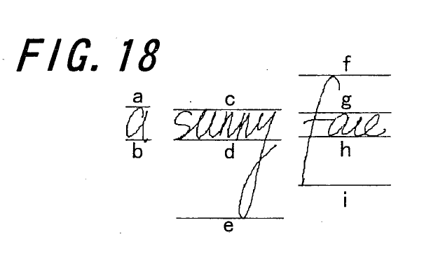

Hence, such written parts of alphabetic characters as deviating largely from heights of the other characters as shown in a detecting process example of FIG. 18, i.e. the written parts between the lines d-e, f-g, and h-i in the example shown in the drawing, are precluded from being detected in defining a circumscribing rectangle.

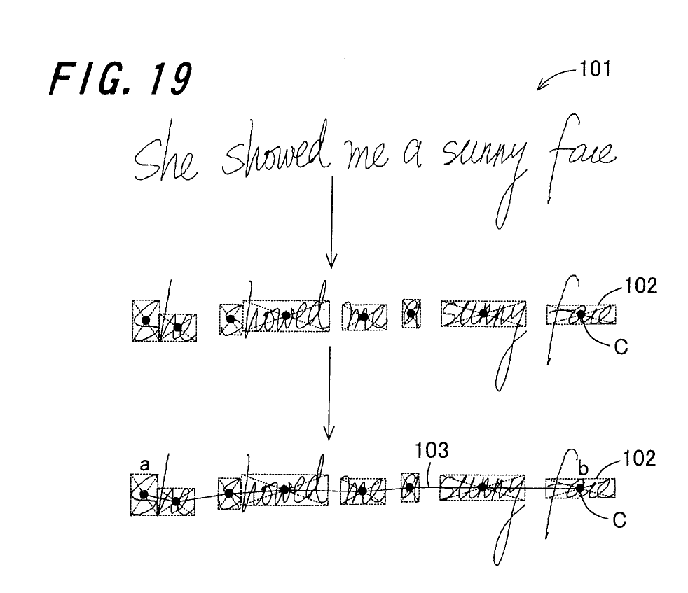

FIG. 19 is a view for explaining how to define a locus of alphabetic characters to be edited. Firstly, one group 101 is divided on a word-basis and then a principle part of each word, i.e. the parts between the lines a-b, c-d, and g-h in the example shown in FIG. 18, is detected. Next, a circumscribing rectangle 102 of each of the principle parts is detected and a geometric center thereof is also detected. Lastly, all the detected centers are connected to one another, thereby defining a locus.

Concrete edit content following completion of the locus definition is similar to that in editing Chinese characters.

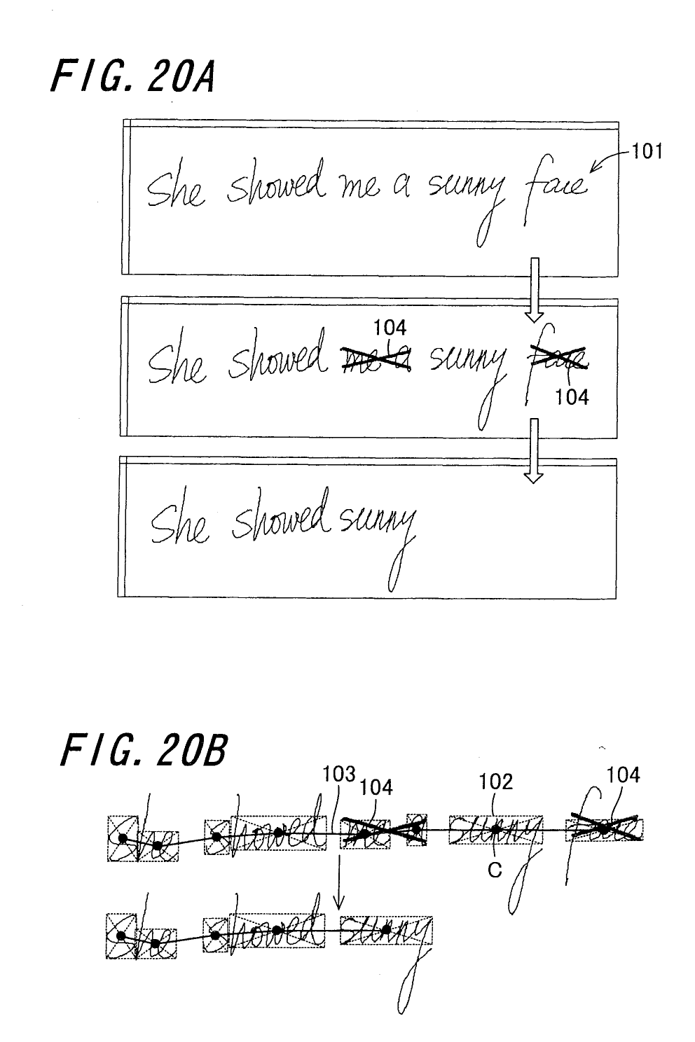

FIGS. 20A and 20B are views each showing an example where a deletion command is inputted as edit content. FIG. 20A shows a display example appearing in performing the deletion task and FIG. 20B shows a view showing concrete processing of display changes.

When the object “X”, namely a deletion gesture 104, is inputted to one group 101 displayed on the handwriting input region 100, then a word object located where the deletion gesture 104 is inputted is deleted, and a word object located after the deleted word object in the input direction is caused to move forward in the input direction so as to follow the locus. A renewed group is thus created and then displayed.

The word object to be deleted is recognized by detecting the circumscribing rectangle(s) 102 including a coordinate (locus) where the deletion gesture 104 is inputted, and selecting a word object that corresponds to the detected circumscribing rectangle(s) 102.

The object remaining after completion of the deletion task is moved so that the center C of the remaining word object is moved along the locus 103 until a left end of the circumscribing rectangle 102 of the moving word object arrives at a position where a left end of the rectangle circumscribing the word object to be deleted used to be located before its deletion.

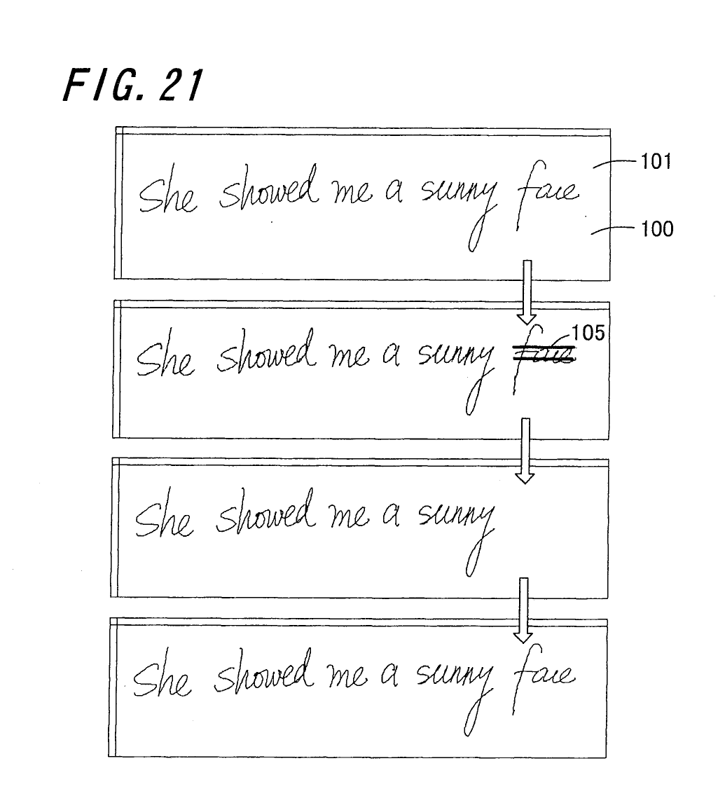

FIG. 21 is a view showing an example where a correction command is inputted as edit content.

When the object “=”, namely a correction gesture 105, is inputted to one group 101 displayed on the handwriting input region 100, then a word object located where the correction gesture 105 is inputted is deleted once. After that, a corrected word object is inputted and this inputted word object is then displayed instead of the deleted word object.

The object to be corrected is recognized by, as in the case of the deletion task, detecting the circumscribing rectangle 102 including a coordinate (locus) where the correction gesture 105 is inputted, and selecting a word object that corresponds to the detected circumscribing rectangle 102.

After input of the corrected word object, its circumscribing rectangle and a geometric center thereof are detected, and the corrected word object is moved so that its center is positioned on the locus and that a left end of the circumscribing rectangle 102 of the moving word object is positioned where a left end of the rectangle circumscribing the word object to be corrected used to be located before its deletion.

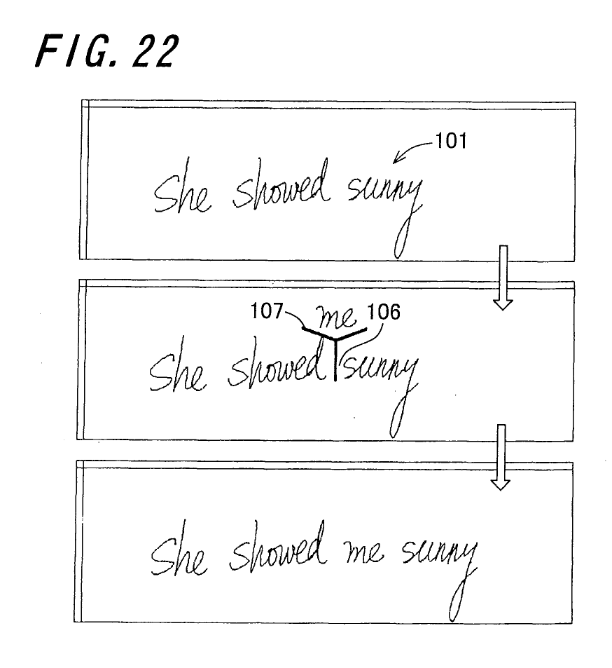

FIG. 22 is a view showing an example where an insert command is inputted as edit content.

When the object “Y”, namely an insert gesture 107, is inputted at an insert position 106 in one group 101 displayed on the handwriting input region 100, then each word object located after the insert position 106 in the input direction is moved along the locus until there will be a predetermined distance left between the each word object located after the insert position 106 in the input direction and the word object located before the insert position 106 in the input direction.

In this case, the word object located at the rearmost end of the group 101 has to move out of the range of the segment indicative of the locus 103 which therefore needs to extend back in the input direction, and along the locus 103 thus extended, the each word object located after the insert position 106 in the input direction moves.

The extension of the locus 103 can be achieved by the heretofore known technique.

Moreover, in positioning the word object to be inserted, the respective centers of the adjacent character objects on either side of the inserted word object are located, and the character object to be inserted is placed so as to have its center positioned on a locus connecting these two centers and at a middle position therebetween.

Next, there is given an explanation of how graphic-containing objects are edited.

The explanation given here is, as an example of edit graphics, of how a flowchart is edited.

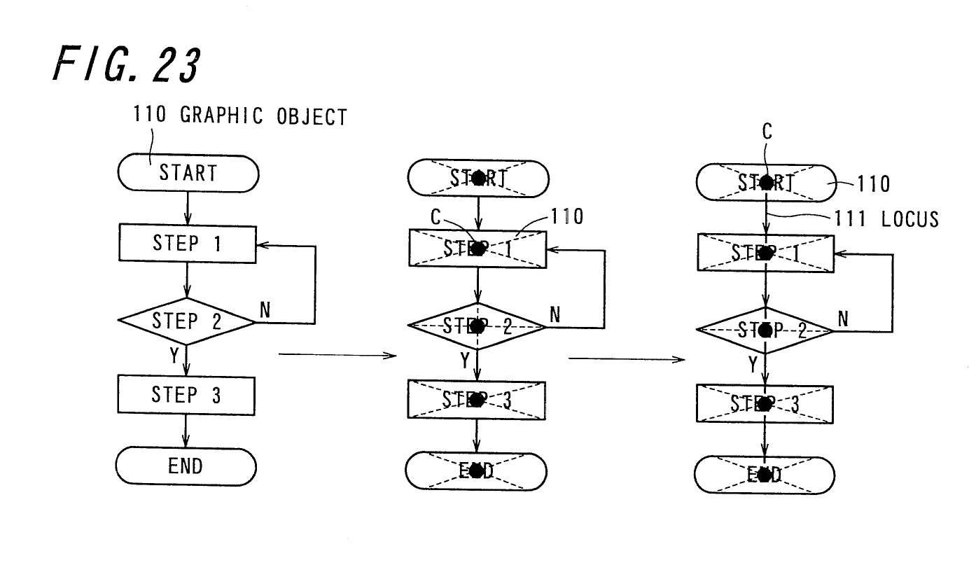

FIG. 23 is a view for explaining how to define a locus of a flowchart to be edited.

A major constituent of the flowchart is a graphic indicative of processing in each step. In the above embodiment of editing a character, a circumscribing rectangle thereof is detected, and now in editing a flowchart having a graphic, a geometric center C of this graphic object 110 is detected.

All the detected centers C are connected to each other, thereby defining a locus 111.

Concrete edit content following completion of the locus definition is similar to that in editing Chinese characters.

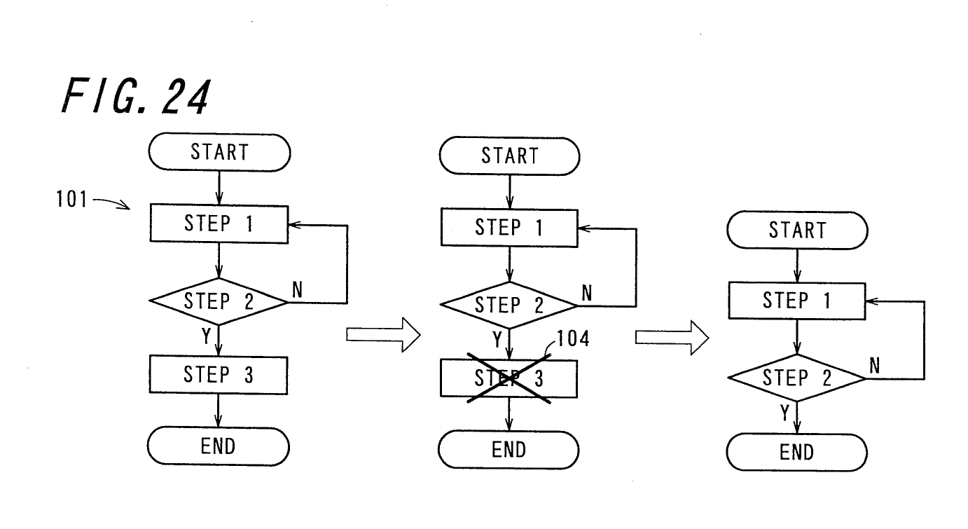

FIG. 24 is a view showing an example where a deletion command is inputted as edit content.

When the object “X”, namely a deletion gesture 104, is inputted to one group 101 displayed on the handwriting input region 100, then a graphic object located where the deletion gesture 104 is inputted is deleted, and a graphic object located after the deleted graphic object in the input direction is caused to move forward in the input direction so as to follow the locus. A renewed group is thus created and then displayed.

The graphic object to be deleted is recognized by detecting the circumscribing rectangle(s) 102 including a coordinate (locus) where the deletion gesture 104 is inputted, and selecting a graphic object that corresponds to the detected circumscribing rectangle(s) 102.

The object remaining after completion of the deletion task is moved so that the center C of the remaining graphic object is moved along the locus until the center position of the moving graphic object coincides with a position at which the graphic object to be deleted used to be centered before its deletion.

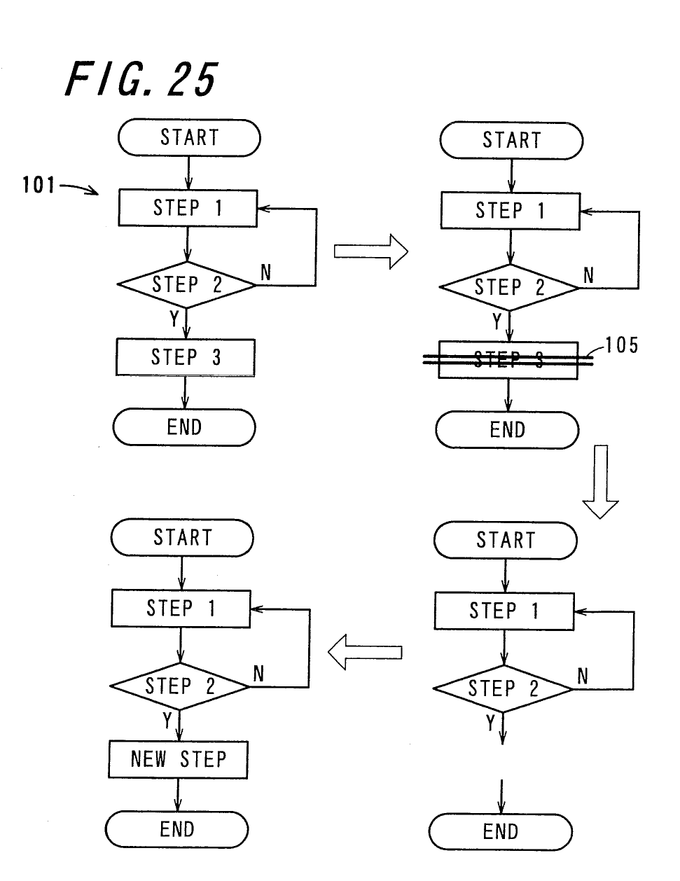

FIG. 25 is a view showing an example where a correction command is inputted as edit content.

When the object “=”, namely a correction gesture 105, is inputted to one group 101 displayed on the handwriting input region 100, then a graphic object located where the correction gesture 105 is inputted is deleted once. After that, a corrected graphic object is inputted and this inputted graphic object is then displayed instead of the deleted graphic object.

The object to he corrected is recognized by, as in the case of the deletion task, detecting the circumscribing rectangle 102 including a coordinate (locus) where the correction gesture 105 is inputted, and selecting a graphic object that corresponds to the detected circumscribing rectangle 102.

After input of the corrected graphic object, a geometric center thereof is detected, and the corrected graphic object is placed so as to have its center positioned on the locus and to leave a predetermined distance from another graphic object adjacent to the position at which the graphic object to be corrected used to be.

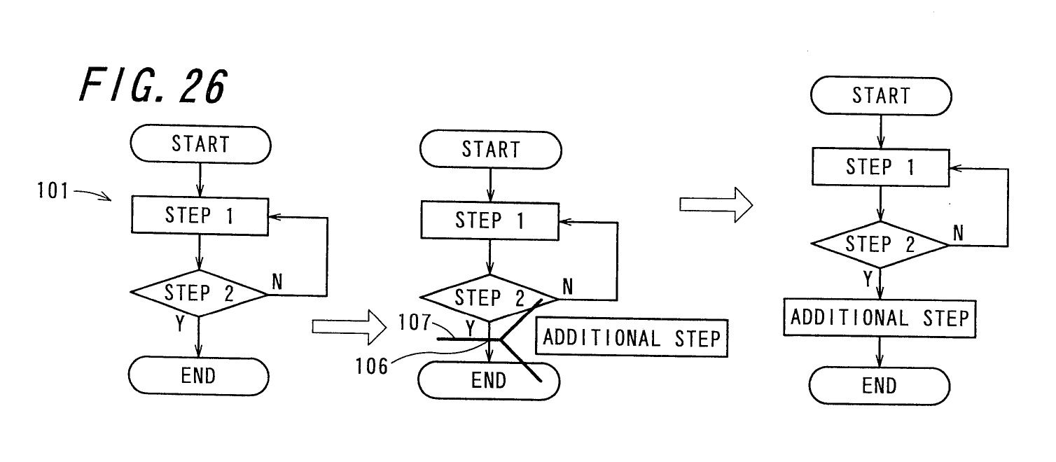

FIG. 26 is a view showing an example where an insert command is inputted as edit content.

When the object “Y”, namely an insert gesture 107, is inputted at an insert position 106 in one group 101 displayed on the handwriting input region 100, then each graphic object located before the insert position 106 in the input direction is moved along the locus so as to leave a predetermined distance from each of graphic objects located after the insert position 106 in the input direction.

In this case, a leading graphic object of the group 101 has to move out of the range of the segment indicative of the locus which therefore needs to extend forward in the input direction, and along the locus thus extended, the each graphic object located before the insert position 106 in the input direction moves.

The extension of the locus can be achieved by the heretofore known technique.

Moreover, in positioning the graphic object to be inserted, the respective centers of the adjacent graphic objects on either side of the inserted graphic object are located, and the graphic object to be inserted is placed so as to have its center positioned on a locus connecting these two centers and at a middle position therebetween.

Note that in conducting such an edit process as the invention, switching is done between a writing mode where characters and text are inputted by hand and an edit mode where the edit process is conducted, and during operation in the edit mode, the edit process based on the handwritten gestures as described above may be conducted.

Switching between the writing mode and the edit mode can be done by the heretofore known technique.

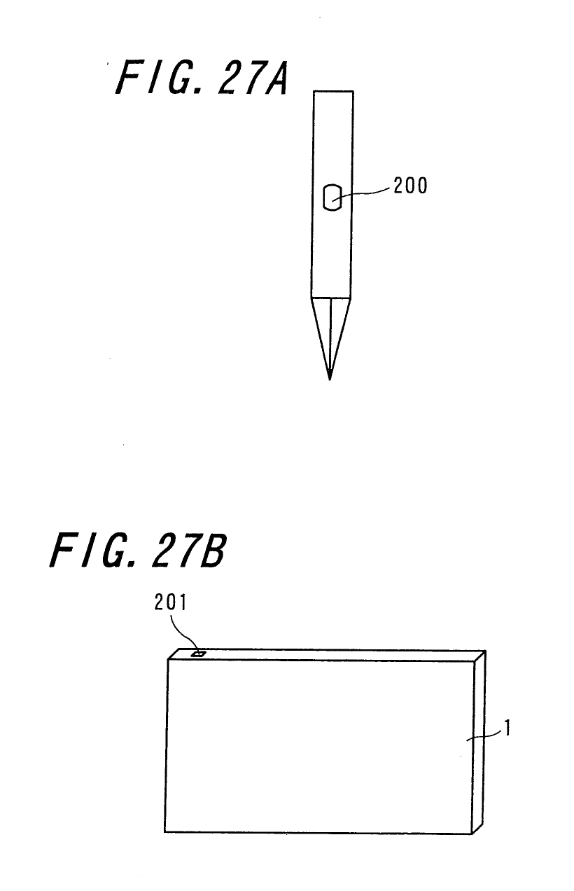

FIGS. 27A and 27B are views for explaining how to switch modes by hardware process.

For example, as shown in FIG. 27A, a pen for use in handwriting input has a switching button 200 and is adapted to switch alternately between the writing mode and the edit mode with every push of the switching button 200. A signal indicative of depression of the switching button is transmitted from the pen to an input apparatus main body through the wired or wireless data communication network. As shown in FIG. 27B, the input apparatus itself is provided with a switching button 201 and adapted to switch alternately between the writing mode and the edit mode with every push of the switching button 201.

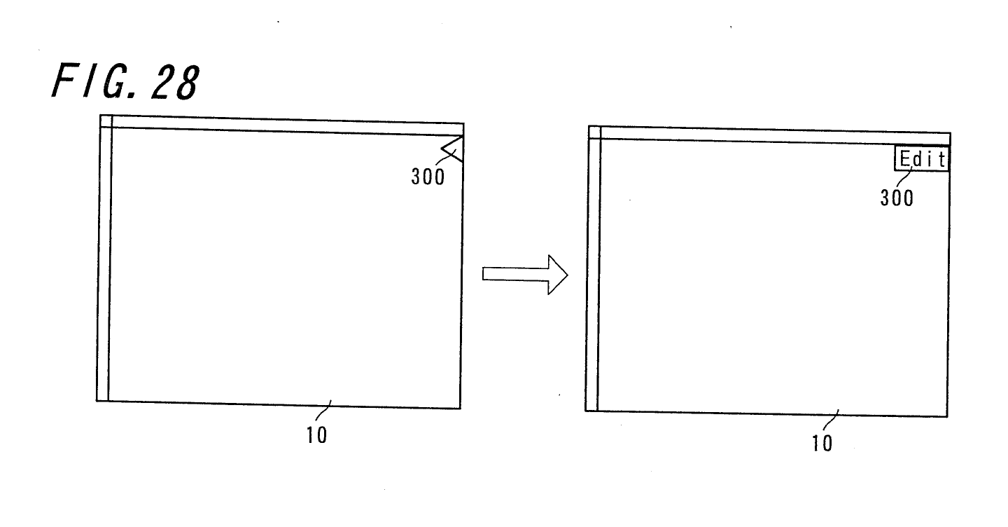

FIG. 28 is a view for explaining how to switch modes by software process.

One of icons in the user interface is allocated to the switching process and when such an icon 300 is touched by the pen, then switching is done between the writing mode and the edit mode.

Further, in another embodiment of the invention, an image processing program for conducting the above edit process may be recorded on a computer readable recording medium on which a program for operating a computer has been recorded.

As a result, it is possible to provide a portable recording medium on which is recorded a program code (an executable format program, an intermediate code program, and a source program) for executing image processing to conduct the edit process.

Note that in the present embodiment, as the recording medium, a memory (not shown because its processing is executed by a microcomputer) such as a read only memory (abbreviated as ROM) itself may serve as a program medium, or alternatively a program reading device (not shown) may be provided as an external storage unit, into which a recording medium is inserted to read a program medium.

In either case, the stored program may be configured to have an access from a microprocessor which is thereby capable of running the program, or alternatively in either case, the system is applicable in which a program code is read out and the read-out program code is then downloaded in a program storage area (not shown) to run the program. This download program is stored in the apparatus main body in advance.

Now, the above program medium is a recording medium which is configured to be removable from the main body, including: a tape type such as a magnetic tape or a cassette tape; a disk type such as a magnetic disk represented by a flexible disk and a hard disk, or an optical disc represented by CD-ROM, MO, MD, and DVD; a card type such as an IC card (including a memory card) or an optical card; or a medium carrying fixed program codes, which includes a semiconductor memory such as a mask ROM, an erasable programmable read only memory (abbreviated as EPROM), or an electronically erasable programmable read only memory (abbreviated as EEPROM).

Further, in the embodiment, the system configuration can be interconnected on the communication network including the Internet, and it is therefore possible to use a medium through which program codes are carried in a streaming manner as downloaded from the communication network. Note that in the case of downloading a program from the communication network, its download program may have been stored in the apparatus main body in advance or may be installed from another recording medium. Moreover, in the invention, the above program code may be in form of computer data signals which are embedded in carrier waves and electronically transmitted.

The above recording medium is read by a program reading device which is disposed in a digital color image forming apparatus or in a computer system, whereby the above image processing method is performed.

The computer system is composed of: an image input device such as a flatbed scanner, a film scanner, or a digital camera; a computer which is loaded with the predetermined program code and therefore executes various processing including the above image processing method; an image display unit which displays processing results of the computer, such as a CRT display or a liquid crystal display; and a printer which outputs the processing results of the computer to paper or the like material. Furthermore, a network card, a modem, or the like component is provided as communication means for making a connection through the network to a server, etc.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An input apparatus comprising:
a handwritten character and/or graphic input device for inputting a character and/or graphic written by hand;
a storage unit for storing handwritten data constituted of handwritten characters and/or graphics inputted by the handwritten character and/or graphic input device;
a handwritten edit command input device for inputting a command of editing the handwritten data by hand;
an input direction detecting unit for detecting an input direction of handwriting a group consisting of a set of characters and/or graphics contained in the handwritten data;
an edit management unit for detecting a command when the command is inputted by the handwritten edit command input device, and controlling the characters and/or graphics in the group so as to move in the input direction during execution of the command; and
a display unit for displaying the handwritten data, handwritten data which has not yet been edited by the edit management unit, and handwritten data which has been edited after the execution of the edit command.

2. The input apparatus of claim 1, wherein the input direction detecting unit detects a rectangle circumscribing each of characters and/or graphics contained in the group and detects a geometric center of the detected circumscribing rectangle to determine a locus connecting all points of the detected geometric center.

3. The input apparatus of claim 2, wherein the edit command includes a deletion command, and
when the deletion command is inputted as a handwritten edit command, the edit management unit deletes a character and/or graphic to be deleted and causes a character and/or graphic located after the deleted character and/or graphic in the input direction to move forward in the input direction so as to follow the locus.

4. The input apparatus of claim 2, wherein the edit command includes a correction command, and
when the correction command is inputted as a handwritten edit command, the edit management unit deletes a character and/or graphic to be corrected; when a character and/or graphic to be corrected is inputted by the handwritten character and/or graphic input device, detects a rectangle circumscribing the inputted character and/or graphic and a graphic center of the circumscribing rectangle; and places the inputted character and/or graphic to be corrected so as to have the detected graphic center positioned on the locus.

5. The input apparatus of claim 2, wherein the edit command includes an insert command, and
when the insert command is inputted as a handwritten edit command, the edit management unit moves along the locus a character located before or after an insert position in the input direction so as to make a predetermined space in between a character and/or graphic located after the insert position in the input direction and a character and/or graphic located before the insert position in the input direction; detects a rectangle circumscribing a character and/or graphic to be inserted which is inputted by the handwritten character and/or graphic input device, and a geometric center of the rectangle; and places the inputted character and/or graphic to be inserted so as to have the detected geometric center positioned on the locus in the space.

6. A computer readable recording medium recorded with an image processing program for operating a computer as the input apparatus of claim 1.
